(19) United States
(12) Patent Application Publication
(10) Pub. No.: US 2026/0109652 A1
(43) Pub. Date: Apr. 23, 2026

(54) CERAMIC WINDOW ASSEMBLY

(71) Applicant: Element Six Technologies Limited, Didcot Oxfordshire (GB)

(72) Inventors: Michael Ian PEARSON, Harwell, Oxfordshire (GB); Teodoro GRAZIOSI, Harwell, Oxfordshire (GB); Francis Mark REININGER, Pasadena, CA (US)

(21) Appl. No.: 19/116,912

(22) PCT Filed: Sep. 27, 2023
(86) PCT No.: PCT/EP2023/076697

§ 371 Date: Mar. 28, 2025

Related U.S. Application Data
(60) Provisional application No. 63/377,811, filed on Sep. 30, 2022.

(30) Foreign Application Priority Data
Oct. 19, 2022 (GB) 2215429.8

(51) Int. Cl. C04B 37/00; C04B 35/52; G02B 1/00

(52) U.S. Cl. CPC C04B 37/003; C04B 35/52; C04B 2235/427; C04B 2237/363; G02B 1/00

(57) ABSTRACT

A ceramic window assembly, comprising a ceramic window, a mount bonded to the ceramic window and comprising an asymmetry; and a superstructure, wherein the superstructure is mechanically stressed.

This invention was made with US Government support under Contract No. FA8651-21-C-0003 awarded by the United States Air Force. The US Government has certain rights in this invention.

### FIELD OF THE INVENTION

The present invention relates to ceramic window assemblies, in particular synthetic diamond windows and mounting configurations for such windows.

### BACKGROUND

Plates of synthetic diamond material are now available in a variety of different grades and for a range of applications. Examples include optical grades of synthetic diamond material for optical applications, thermal grades of synthetic diamond material for thermal management in semiconductor applications, and electrically conductive boron doped diamond grades for electrodes in electrochemical applications. Synthetic diamond materials have a number of advantageous features for such applications including extreme hardness, high optical transparency across a wide frequency range and across a wide field of view, high thermal conductivity, and chemical inertness.

There remain several problems in utilizing synthetic diamond plates for certain applications. One of the main limitations for applications which require large area plates is that plates of synthetic diamond material are only available up to a certain size. This size limitation is a result of the difficulty in generating and maintaining the extreme conditions required to grow diamond material over a large area. The largest high quality synthetic diamond plates currently available are polycrystalline chemical vapour deposited (CVD) diamond plates which can be fabricated as circular wafers up to around 120 mm in diameter. The circular symmetry of such large area wafers is inherent from the circular symmetry of the microwave plasma activated chemical vapour deposition apparatus used in the synthesis process, but other shapes can also be created.

While synthetic diamond plates have extreme hardness and resistance to scratching, the diamond material is brittle and can be prone to fracture if not mounted and handled correctly. Furthermore, the combination of high hardness and low toughness can make diamond material difficult to process into precise geometries without fracturing the material or introducing significant surface and sub-surface damage. Further still, while the chemical inertness of diamond can be an advantage for many applications, it does mean that diamond components can be difficult to bond into mounting configurations using standard adhesives and mounting structures. Further still, while the low thermal expansion coefficient of diamond material can be advantageous, for example to avoid thermal lensing effects, the rigidity of the diamond material in combination with a thermal expansion mismatch to the mounting material can lead to thermally induced stresses and potential de-bonding or fracture of the diamond component.

Ceramic materials, such as diamond, typically have high compressive strength but their tensile strength is comparatively low. These materials are brittle and so their mechanical failure threshold is determined by the largest flaw in a region under tensile stress. The distribution of flaws results in a statistical distribution of threshold stresses, dependent on critical flaw size. When these materials fail under stress, the mechanism is typically brittle fracture, leading to catastrophic failure of a component. Due to a low tensile strength compared to compressive strength, statistical distribution of strengths, and brittle fracture mechanism, it is desirable to design ceramic components so they are primarily in compression, while avoiding tensile forces. If is not possible to avoid tensile forces, large safety margins are required to ensure a component does not fail in use.

Most ceramic materials have a low coefficient of thermal expansion (CTE) compared to metals. When a ceramic window is bonded to a metallic mount, the bonding process is typically carried out at a high temperature. Both parts, the ceramic window and the metallic mount, are typically under low stress during the bonding process, or directly after the bonding while the temperature is still high. However, when subsequently the window and the attached metallic mount cool down, the metallic mount will contract more than the ceramic material, causing significant stress in the mount and the window.

### STATEMENT OF INVENTION

According to a first aspect of the invention, there is provided a ceramic window assembly, comprising: a ceramic window; a mount bonded to the ceramic window and comprising an asymmetry perpendicular to a plane of the ceramic window; and a superstructure, wherein the superstructure is mechanically stressed. The asymmetry perpendicular to the plane of the ceramic window may be caused, for example, by a bonding to a mount only on one plane surface of the ceramic window and not also on the opposite plane surface of the ceramic window.

The superstructure may be arranged to reduce tensile stress within the window, and/or to turn tensile stress into compressive stress.

The material of the ceramic window may be synthetic diamond, and in a more particular example, the material may be polycrystalline chemical vapour deposited diamond.

The superstructure may be mechanically connected to the mount during attachment of the mount to the ceramic window, and removed from the mount after attachment of the mount to the ceramic window. The inner diameter of the superstructure may match the outer diameter of the mount.

The thermal expansion coefficient of the superstructure may be lower than the thermal expansion coefficient of the mount.

The superstructure may be a second ceramic window, bonded to the mount on a side of the mount opposite to the side the ceramic window is attached to. The dimensions of the second ceramic window may substantially be the same as the dimensions of the ceramic window.

The superstructure may extend in a main plane of the window assembly, and may comprise a shape in the main plane substantially matching the shape of the mount.

An example of material of the mount is a metallic material, and, an example of suitable metal is molybdenum.

The material of the superstructure may have a lower coefficient of thermal expansion than the coefficient of thermal expansion of the mount. Examples of materials of the superstructure are: ceramic, synthetic diamond, tungsten, or fused silica.

The ceramic window optionally has a maximum deflection, measured perpendicular to a main plane of the window of no more than 4.5×10⁻⁵ times a longest linear dimension of the window, and preferably no more than 2.0×10⁻⁵ times the longest linear dimension of the window. It is beneficial to reduce deflection to ensure that lensing of light or other radiation passing through the ceramic window is minimised.

As an option, the ceramic window has a largest linear dimension selected from any of between 10 mm and 130 mm, between 20 mm and 60 mm, and between 25 mm and 50 mm.

The ceramic window optionally has an average thickness selected from any of between 200 μm and 1500 μm, between 300 μm and 1000 μm, and between 400 μm and 800 μm. In practice, a thicker ceramic window is less prone to deflection but is more highly stressed, whereas a thinner ceramic window has lower stress but is more prone to deflection.

As a further option, the ceramic window has a peak to valley flatness selected from any of less than 100, less than 80 and less than 40×λ/2 interference fringes over a largest linear length of the ceramic window. Flatness can be measured using a 633 nm light interferometer. Optical interference creates a fringe pattern, and each fringe corresponds to a λ/2 variation in flatness. The number of λ/2 interference fringes is therefore a measure of the flatness of the ceramic window.

According to a second aspect of the invention, there is provided a method of manufacturing a ceramic window assembly according to the first aspect, the method comprising: providing the ceramic window, providing the mount, providing the superstructure, and attaching the superstructure to the mount, bonding the mount to the window; and creating stress in the superstructure.

The method may further comprise removing the superstructure from the ceramic assembly after bonding the mount to the window.

The step of creating stress may occur when heating the ceramic window assembly for bonding the mount to the ceramic window. Alternatively, the step of creating stress may occur when cooling the ceramic window assembly down from an elevated temperature used for bonding the mount to the ceramic window.

According to a third aspect, there is provided an optical device, comprising a ceramic window assembly according to the first aspect.

### FIGURES

Some embodiments of the invention will now be described by way of example only and with reference to the accompanying drawings, in which:

FIG. 1 is a top view of two schematic window assemblies with asymmetric mounts;

FIG. 2 is a top view of two schematic window assemblies comprising a constraining superstructure;

FIG. 3 is a side view of two schematic window assemblies comprising superstructures;

FIG. 4 illustrates a window assembly with bridge portions as superstructures;

FIG. 5 illustrates a top view and cross section of a window assembly and a superstructure; and

FIG. 6 illustrates stress modelling of an asymmetric window assembly with no constraining superstructure;

FIG. 7 illustrates stress modelling of an asymmetric window assembly with a constraining superstructure;

FIG. 8 is a method flow diagram.

### SPECIFIC DESCRIPTION

The inventors have realised that the stress in a ceramic window and an attached mount can be managed by controlling the distribution of stress across the window, and in particular to mitigate tensile stress on the window. One or more additional structural components, also called superstructures herein, can be used to turn tensile stress into compressive stress. Ceramic windows have a much higher failure threshold under compressive stress than under tensile stress.

As described above, a ceramic window is bonded to a metallic mount at a high temperature. One of the reasons for the high temperature may be a requirement for the window assembly including the bond to be used in operational temperatures up to 800° C. The bond between the mount and the window must maintain integrity up to at least such an operational temperature. A bond may be created at a high temperature to ensure that the bond can withstand high temperatures. For example, a gold based braze with an approximate melting temperature of 1100° C. could be used. Another example of a high temperature bond is an Ag—Ti braze. However, lower temperature diffusion bonds are also a possibility. Both parts, i.e. the ceramic window and the metallic mount, are typically not under stress during the bonding process, or directly after the bonding while the temperature is still high. However, when the window and the attached metallic mount cool down, the metallic mount contracts more than the ceramic material, causing stress both in the mount and the window. The inventors have realised that if the mount shape is symmetric relative to the plane of the ceramic window, the window is primarily under compressive stress after cooling down, and the risk of fracture of the window is often below a critical failure threshold. The risk of fracture is below the critical failure threshold due to the high compressive strength of ceramic materials relative to that of other materials, or relative to tensile strength of the ceramic materials.

If, however, the use of the mounted window requires an asymmetric mount due to technical design constraints, the asymmetric contraction of the metal mount will cause a bending moment in the window, introducing tensile stress to the window. A deformation of the window in the direction perpendicular to the main plane may occur. There may also be some degree of ‘pulling’ of the ceramic window. In case of a diamond window, the pulling acts as a force that separates the atoms in the lattice structure, opposed to a preferred compressive force pushing the atoms closer together. In practice, there may be a combination of these different undesired effects, and it is not always possible to determine individual contributions of deformation, pulling, and other effects causing tensile stress in the ceramic material. Therefore, the mounts with superstructures proposed herein have partially been arrived at through an empirical inventive process, and not only through theoretical considerations.

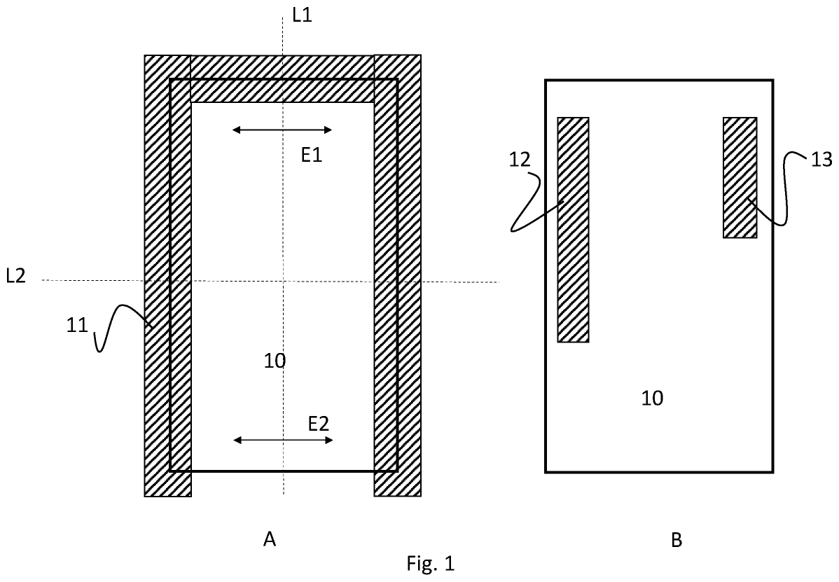

FIG. 1 illustrates two examples of asymmetric mounts. In FIG. 1A, a window 10 is supported by a U-shaped mount 11. The mount has an axis of symmetry around line L1, but is not symmetrical around line L2. If the lower part of the window were also supported by a mount, and the U-shape were an ‘O-shape’, the mount would also be symmetrical around line L2, which would reduce tensile stress. The mount being provided on only one side of the window is another cause of tensile stress, typically larger than the tensile stress caused by the asymmetry around the line L2.

An example of an operating condition requiring a U-shaped mount is an optical application where light needs to be transmitted through the lower part of the window. When cooling down, the top of the mount will contract, but the lower part of the window does not have a corresponding mount section that mirrors the contraction of the top of the mount, causing an asymmetry in contracting forces, and tensile stress onto the window. FIG. 1B illustrates another asymmetric mount, comprising a first part 12 bonded to the left side of window 10, and a second part 13 bonded to the right side of the window. The first part 12 is larger than the second part 13, causing an asymmetry and corresponding tensile stress during changes in temperature. The contraction of the mount when cooling down and corresponding stress illustrated by double arrow E1 at the top will not be the same as those of arrow E2. Stresses E1 and E2 are in the main plane of the window, but stresses may also occur in the direction normal to the main plane of the window and perpendicular to E1 and E2 but also in the plane of the window.

A further example of an asymmetric mount is an oval shaped mount, as opposed to a circular shaped mount. An oval shape has only two axes of symmetry in the main plane of the shape, while a circular shape is symmetrical around any line through the centre of the circle in the main plane of the mount. Although a circular shape may be preferable to reduce tensile stress, it is not always a preferable shape for the use-scenarios. For example, the field of view of a circular mount may be too small for a particular application. The presence of a mount on one side of the window, as opposed to both sides, is also a large source of tensile stress, both for a circular window and an oval window.

The inventors have devised a superstructure to reduce or avoid tensile stress. Some or all of the asymmetric forces are reduced. The superstructure may be arranged to reduce the total amount of stress on the window, or symmetrise the stresses without reducing the overall amount of stress, thereby reducing tensile stress, or a combination of reducing and symmetrising the stress. As will be illustrated in more detail in the examples below, the superstructures may also be considered to be ‘turning’ tensile stress into compressive stress. A bending moment is also avoided or reduced by the superstructure.

A ceramic window assembly is accordingly provided, comprising a ceramic window and a mount bonded to the window. The mount comprises an asymmetry. The assembly further comprises a superstructure, wherein the superstructure is mechanically stressed. The stress of the superstructure relieves the tensile stress on the window.

It is noted that the feature of the superstructure being stressed would primarily be considered a structural feature rather than a functional feature, because the stress can objectively be observed and measured, and it is intrinsic to the specific arrangement. The stress is a feature of the material in the assembly, rather than a feature of a method carried out by an external process.

The superstructure brings the tensile stresses well under a failure threshold, thereby preventing damage to the window, even if compressive forces may be increased by the superstructure.

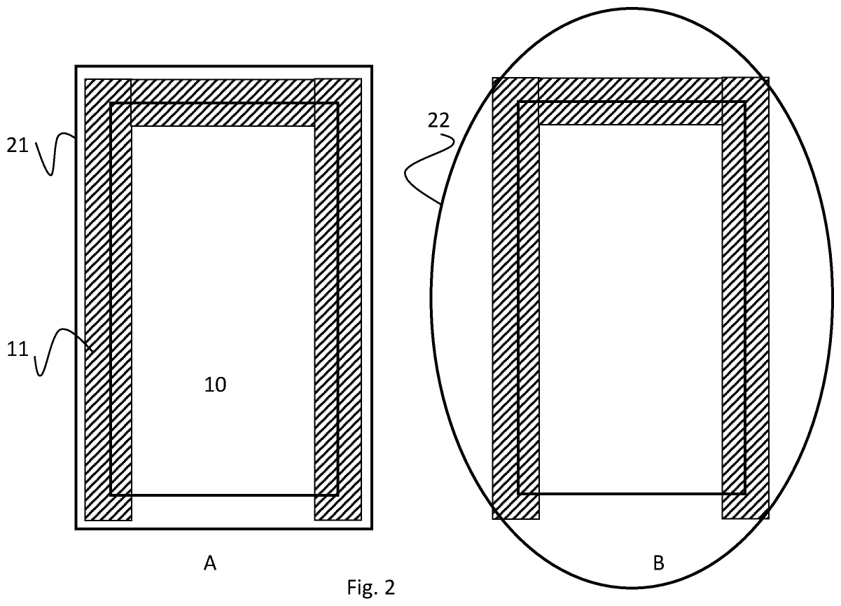

A first example of a superstructure is a constraining superstructure arranged to limit deformation of the mount during heating. The superstructure limits the deformation of the mount during the bonding process and will thereby cause stress in the mount and in the superstructure, but not in the window, and not within the mount after subsequent cooling down either. The superstructure is sufficiently strong to withstand the stress caused by the expansion of the mount, and comprises a material with a lower thermal expansion coefficient than that of the metal mount. An example of a material is a ceramic material, but other materials may be used. FIG. 2A illustrates the assembly of FIG. 1A schematically, including window 10 and mount 11, with an additional superstructure 21. The superstructure 21 has inner dimensions matching the outer dimensions of the mount 11 when the mount is at a lower temperature such as room temperature, and comprises a strong ceramic material or other material with a low thermal expansion coefficient. The matching of the dimensions is intended to prevent expansion of the mount, but the superstructure may also have slightly larger dimensions depending on the relative coefficients of thermal expansion and the bonding temperature. The superstructure is placed around the mount before heating the assembly for the bonding process. When the assembly with the superstructure is heated up, the mount and superstructure will become stressed due to the constriction caused by the superstructure. After the bonding process has been completed, the assembly is cooled down and the stress will disappear. In this embodiment, the technical effect of the superstructure after cooling down is that of removing stress, rather than turning tensile stress into compressive stress.

If the mounted window is used in high temperature applications, the superstructure may need to stay in place, but if the mounted window is used only for low temperature applications, the superstructure can be removed after the high temperature bonding process has been completed. The reason for the superstructure optionally staying in place is that tensile stress may be caused by a reverse scenario to that discussed in relation to FIG. 1A, whereby at room temperature (or other lower operational temperature) there is no or little tensile stress, while at a high temperature excess tensile stress occurs. This is the opposite to the scenario discussed in relation to FIG. 1A, because without the superstructure there may be no or little tensile stress at the high temperature during the bonding process, but excess tensile stress after cooling down.

FIG. 2B illustrates a different example of a constraining superstructure. The superstructure is oval shaped or round shaped. A disadvantage when compared to the shape of FIG. 2A is that there are fewer contact points, which may cause deformation, such as buckling, of the mount and the window. There are four constriction contact points between the superstructure and the mount, at the four corners of the mount. This structure may therefore be less preferred, because the mismatch between the shape of the mount and the shape of the superstructure can cause buckling of the mount and/or window. However, if the superstructure of FIG. 2B is used for an oval mount with a shape matching that of the superstructure, it would be suitable again for preventing tensile stress.

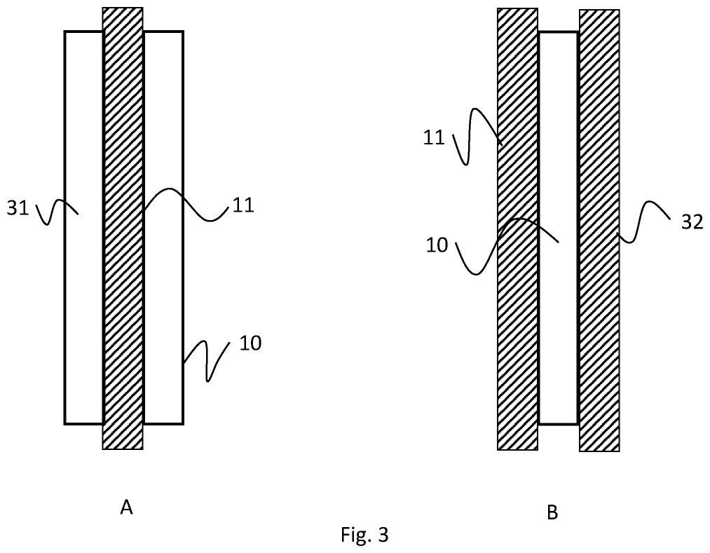

The asymmetry of the mount being provided on one side of the window, but not the other side, also causes tensile stress as discussed above. FIG. 3 illustrates an assembly wherein the superstructure is a second ceramic window on the opposite side of the mount. FIG. 3A is a schematic side view, with window 10 and mount 11 corresponding to the likewise numbered parts in FIGS. 1 and 2. A second window 31 is provided. Preferably, the dimensions and the material properties of the second window are the same, or very similar, to those of the first window. Preferably, the orientation of the first and second windows is symmetrical around the main plane of the mount. The technical effect of the symmetry, and same dimensions and material properties, is a reduction in the tensile stress. However, some of the parameters of dimensions, material and orientation may be varied while achieving the same effect. For example, if the material of the first window is diamond, and a different material with a lower cost is selected for the second window with a slightly different thermal expansion coefficient, the dimensions of the window may be chosen differently to achieve the same overall effect of cancelling the bending moment.

FIG. 3B is a schematic side view, with window 10 and mount 11 corresponding to the previously described window and mount. Instead of the superstructure being an additional window, it is an additional mount 32 which mirrors the mount 11 in order to restore or improve symmetry in the direction perpendicular to the main plane and remove the bending moment. An advantage over the embodiment illustrated in FIG. 3A is a reduced cost, because a metallic mount typically has a lower cost than a diamond window. However, this approach may not be suitable depending on design restrictions.

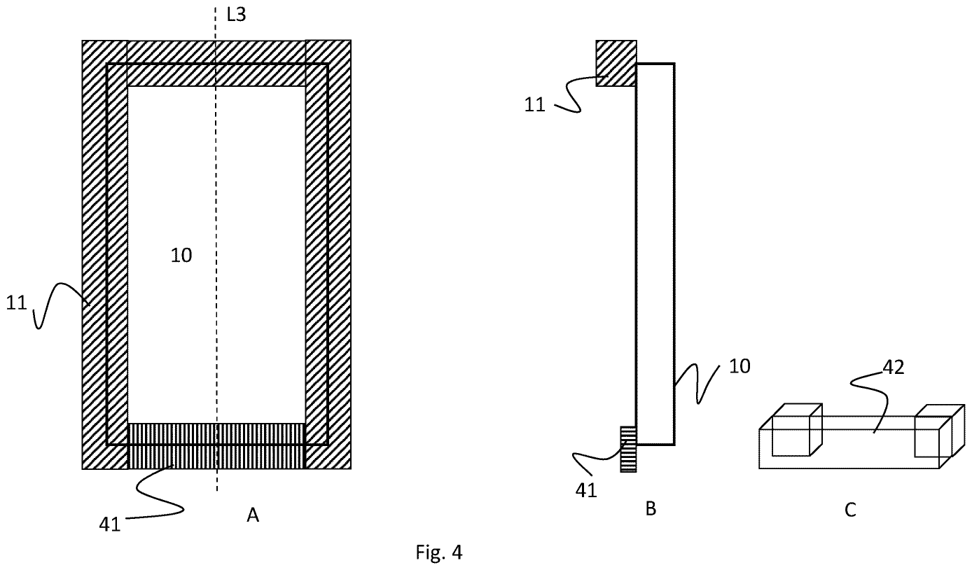

A further example of a superstructure is illustrated in FIG. 4 A. A window 10 and mount 11 are provided as before by way of a non-limiting example of an asymmetric window. A superstructure 41 is provided to close the gap between the two legs of the U-shaped mount 11. The superstructure has a smaller thickness than the mount 11, such that the superstructure does not provide an obstruction in a beam path, which is an example of a reason for omitting a mount on that side of the window. FIG. 4 B is a vertical cross section along line L3 shown in FIG. 4A, showing the smaller thickness in the direction perpendicular to the main plane of the window. The material of the superstructure is chosen such that the thermal expansion matches that of the rest of the window, and tensile stress in the window is avoided. A relatively thin layer of material which has a high Young's modulus and a high coefficient of thermal expansion can be used to recover a symmetric stress state, despite the structure geometry not being symmetrical.

Materials can be selected to achieve the technical effect of compensating for a thinner structure with a lower CTE. The material of the superstructure could be one of: a ceramic, synthetic diamond, tungsten, or fused silica material. Each of these options could be combined with the mount material being molybdenum.

FIG. 4C is a schematic illustration of a variation of the superstructure 41, whereby a bridge portion 42 is provided. The bridge portion 42 is connected to both legs of the U-shaped mount, but not to the window. Like superstructure 41, the bridge portion 42 creates a symmetrical distribution of stress, thereby avoiding tensile stress and only providing compressive stress.

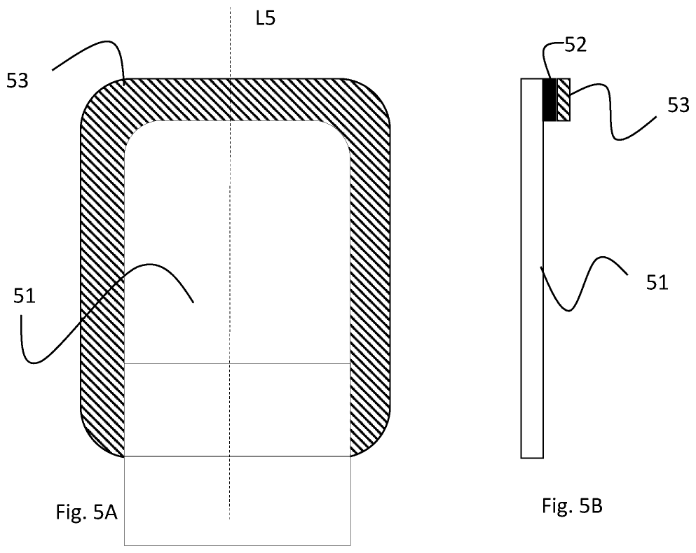

A further example is illustrated in FIGS. 5A and 5B. FIG. 5A is a top view, and FIG. 5B is a cross section along line L5 of FIG. 5A. A window 51 is attached to a mount 52. The shape of the mount may be as described previously, i.e. a U-shape, O-shape, oval or round shape, or any other shape determined by design specifications. A generally rectangular shape is illustrated with rounded corners. The rounded corners provide a smoother transition between the sides and a reduction of possible stresses. A superstructure 53 is attached to the side of the mount opposite to the side the window is attached to. Instead of bonding an entire window to the back of the mount, as illustrated in the FIG. 3A embodiment, a superstructure with a low coefficient of thermal expansion material, such as diamond or fused silica is bonded to the back of the mount. The superstructure may have a shape the same or similar to that of the mount, such as a U-shape, O-shape, oval or round shape, or any other shape of the mount. However, there does not need to be an exact match between the shape, and the superstructure may be slightly larger, while still achieving the same technical effect of accepting some stress to reduce the tensile stress in the window, as well as avoiding the costs of a full window. The superstructure in FIG. 5A matches the shape of the mount, so in the top view it is not possible to see the mount underneath the superstructure.

Optionally, the mount may define a cooling channel for guiding a cooling liquid during use. A reduced temperature of the mount will reduce the expansion and any associated stresses.

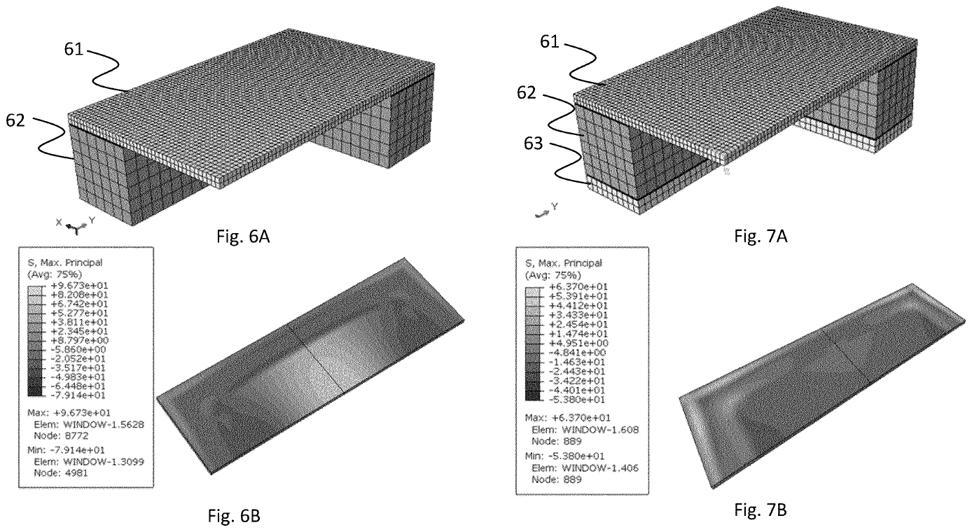

FIG. 6 illustrates stress modelling of an asymmetric window assembly with no constraining superstructure. The modelling was performed using Abaqus, assuming a polycrystalline diamond window having dimensions of 40 mm×25 mm×600 μm, and a mount made from molybdenum. The diamond to molybdenum bond was modelled as a 100 μm thick high temperature braze, assumed to be perfectly plastic.

FIG. 6A shows a meshed isometric view of a quarter of the window assembly. The quarter of the ceramic window 61 shown is bonded to the mount 62. As can be seen from FIG. 6B, which shows a plot of the modelled principal stress, high stresses develop away from the mounted regions of the diamond window, with a modelled maximum tensile stress of 96.73 MPa.

In comparison, FIG. 7 illustrates stress modelling, using the same assumption as those listed above for FIG. 6, of an asymmetric window assembly with a mechanically stressed constraining superstructure. FIG. 7A a meshed isometric view of a quarter of the window assembly along with the mechanically stressed constraining superstructure 63. As can be seen from FIG. 7B, which shows a plot of the modelled principal stress, the modelled stresses that develop in the ceramic window are much lower than those shown in FIG. 6B, with a modelled maximum tensile stress of 63.70 MPa.

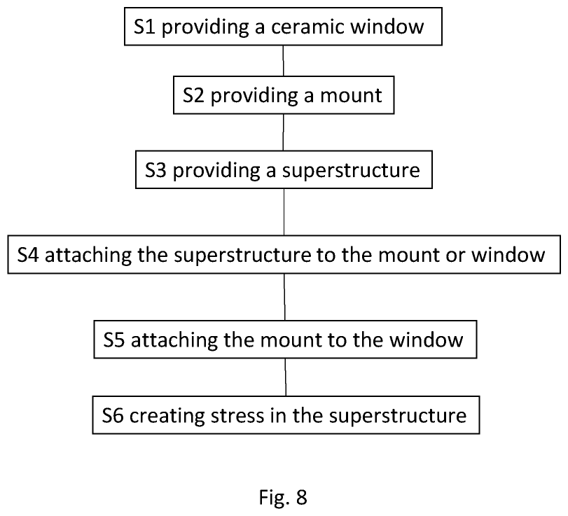

FIG. 8 illustrates a method. The method defines manufacturing a ceramic window assembly according to the steps of: S1 providing the ceramic window, S2 providing the mount, S3 providing the superstructure, and S3 attaching the superstructure to the mount or to the ceramic window, S4 bonding the mount to the window; and S5 creating stress in the superstructure. The order of the steps may be changed. For example, the attaching of the superstructure to the mount or window may be carried out before, or after the attaching of the mount to the window, or the steps may substantially take place at the same time. The final step of creating stress may be carried out by changing the temperature of the assembly, whether by increasing or decreasing the temperature, as described previously.

While this invention has been particularly shown and described with reference to embodiments, it will be understood to those skilled in the art that various changes in form and detail may be made without departing from the scope of the invention as defined by the appending claims.

1. A ceramic window assembly, comprising:
a ceramic window;
a mount bonded to the ceramic window and comprising an asymmetry in a direction perpendicular to a plane of the ceramic window; and
a superstructure, wherein the superstructure is mechanically stressed.

2. The ceramic window assembly of claim 1, wherein the superstructure is arranged to reduce tensile stress within the window, and/or to turn tensile stress into compressive stress.

3. The ceramic window assembly of claim 1, wherein the material of the ceramic window is synthetic diamond, and optionally polycrystalline chemical vapour deposited diamond.

4. The ceramic window assembly of claim 1, wherein the superstructure is mechanically connected to the mount during attachment of the mount to the ceramic window, and removed from the mount after attachment of the mount to the ceramic window.

5. The ceramic window assembly of claim 4, wherein the inner diameter of the superstructure matches the outer diameter of the mount.

6. The ceramic window assembly of claim 4, wherein the thermal expansion coefficient of the superstructure is lower than the thermal expansion coefficient of the mount.

7. The ceramic window assembly of claim 1, wherein the superstructure is a second ceramic window, bonded to the mount on a side of the mount opposite to the side the ceramic window is attached to.

8. The ceramic window assembly of claim 7, wherein the dimensions of the second ceramic window are substantially the same as the dimensions of the ceramic window.

9. The ceramic window assembly of claim 1, wherein the superstructure extends in a main plane of the window assembly, and comprises a shape in the main plane substantially matching the shape of the mount.

10. (canceled)

11. The ceramic window assembly of claim 1, wherein the material of the superstructure has a lower coefficient of thermal expansion than the coefficient of thermal expansion of the mount.

12. The ceramic window assembly of claim 11, wherein the material of the superstructure is one of: ceramic, synthetic diamond, tungsten, or fused silica.

13. The ceramic window assembly of claim 1, wherein the ceramic window has a maximum deflection, measured perpendicular to the plane of the window of no more than 4.5×10⁻⁵ times a longest linear dimension of the window, and preferably no more than 2.0×10⁻⁵ times the longest linear dimension of the window.

14. The ceramic window assembly of any claim 1, wherein the ceramic window has a largest linear dimension selected from any of between 10 mm and 130 mm, between 20 mm and 60 mm, and between 25 mm and 50 mm.

15-16. (canceled)

17. A method of manufacturing a ceramic window assembly according to claim 1, the method comprising: providing the ceramic window, providing the mount, providing the superstructure, and attaching the superstructure to the mount, bonding the mount to the ceramic window; and creating stress in the superstructure.

18. The method of claim 17, further comprising removing the superstructure from the ceramic assembly after bonding the mount to the window.

19. The method of claim 18, wherein the creating stress occurs when heating the ceramic window assembly for bonding the mount to the ceramic window.

20. The method of claim 17, wherein the creating stress occurs when cooling the ceramic window assembly down from an elevated temperature used for bonding the mount to the ceramic window.

21. The method according to any one of claims 17 to 20 claim 17, further comprising mechanically processing the ceramic window after bonding the mount to the ceramic window.

22. An optical device, comprising a ceramic window assembly according to any claim 1.
